(19) United States
(12) Patent Application Publication
(10) Pub. No.: US 2006/0059131 A1
(43) Pub. Date: Mar. 16, 2006

(54) Method and apparatus for using additional service data interactively, and receiver using the method and apparatus

(75) Inventors: Sun-hee Youm, Suwon-si (KR); Jeong-hoon Park, Seoul (KR); Sung-ll Park, Suwon-si (KR); Ju-hee Park, Suwon-si (KR); Ju-hee Seo, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRICS CO., LTD., Suwon-si (KR)

(21) Appl. No.: 11/127,317

(22) Filed: May 12, 2005

(30) Foreign Application Priority Data
Jun. 11, 2004 (KR) 2004-0043073

(51) Int. Cl. G06F 17/30

(52) U.S. Cl. 707/3

(57) ABSTRACT

A method and apparatus for interactively using additional data in digital audio broadcasting. The method of interactively using additional data includes: receiving additional data and storing the received additional data in a specified database; receiving a user input via a user input interface obtained by decoding information regarding a screen composition contained in service data, transforming the user input into a query that requests a search of the database, and outputting the query; and searching the database in response to the query and outputting a result of the searching.

### CROSS-REFERENCE TO RELATED APPLICATION

This application claims the priority of Korean Patent Application No. 2004-43073, filed on Jun. 11, 2004, in the Korean Intellectual Property Office, the disclosure of which is incorporated herein by reference.

### BACKGROUND OF THE INVENTION

1. Field of the Invention

The present invention relates to digital audio broadcasting (DAB), and more particularly, to a method of and apparatus for providing additional information by receiving the additional information in a specified database in a packet mode, storing it, and searching for the additional information in the database and providing it to a user in response to a user input, and a receiver capable of receiving the additional information.

2. Description of Related Art

FIG. 1 is a diagram illustrating a method of interactively processing a user input in a digital audio broadcasting (DAB) system. Referring to FIG. 1, when a user requests additional information from a DAB service currently transmitted by a broadcast station 110, a database 120 storing the additional information is accessed via a return channel 125 and the additional information from the database 120 is provided to the user. For instance, while receiving sports relay broadcasting, a caption containing information related to a player may be displayed on a DAB receiver 130. In this case, the user can interactively request a detailed profile of the player via an input unit. For instance, when the name of a player is displayed as a caption and the user selects the name via a user interface such as a touch screen, a mouse, or a stylus pen, information in a database that stores a detailed profile about the player is parsed, the database is accessed via the return channel according to the result of parsing, and the detailed profile is provided to the user.

However, if the return channel is not secured, it is not possible to allow interaction between the user and the broadcast station. In this case, it is impossible to provide a user with additional data during reproduction of a received service.

### BRIEF SUMMARY

An aspect of the present invention provides a method and apparatus for providing additional data by storing all received additional data in a database of a digital audio broadcasting (DAB) receiver, and searching for data that a user requests to receive from the database, and providing the user with the desired data irrespective of whether a return channel exists, and a receiver for receiving the additional information.

According to one aspect of the present invention, there is provided a method of interactively using additional data, the method including: receiving additional data and storing the received additional data in a specified database; receiving a user input via a user input interface obtained by decoding information regarding a screen composition contained in service data, transforming the user input into a query that requests a search of the database, and outputting the query; and searching the database in response to the query and outputting a result of the searching.

The database may be a relational database. The relational database may include a field including at least one pair of a field label that categorizes stored data and a field type that represents a format in which the field label is stored, and field data including at least one pair of an index, and at least one piece of data corresponding to the index and a length of the data.

The additional data may be received in a packet mode in digital audio broadcasting. The information regarding the screen composition may be received in a stream mode in digital audio broadcasting, and binary format for scene (BIFS) data.

According to another aspect of the present invention, there is provided an apparatus for processing additional data, including: a local database receiving the additional data and storing the received additional data; and a decoder decoding information regarding a screen composition to make a user input interface, receiving a user input via the user input interface, transforming the user input into a query that requests a search of the local database, and outputting the query.

The local database may receive the query, search data in the local database, and output the result of the searching.

According to another aspect of the present invention, there is provided a digital audio broadcast (DAB) system, including: a broadcast station transmitting binary format for scene (BIFS) data in a stream mode and additional data in a packet mode; a receiver having a BIFS decoder and a database, the receiver receiving the transmitted BIFS data and the transmitted additional data, storing the received additional data in the DB, the BIFS decoder decoding the received BIFS data to obtain a BIFS node receiving user input; and a user interface. When a user input is received by the user interface, a query regarding the user input is made using the BIFS node and the database is searched to satisfy the query.

According to other aspects of the present invention, there are provided computer-readable storage media encoded with processing instructions for causing a processor to perform various method of the invention.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a diagram illustrating a conventional method of interactively processing a user input in a digital audio broadcasting (DAB) system;

FIG. 2 is a diagram illustrating the relationship among a service, service components, and sub channels according to an embodiment of the present invention;

FIG. 3 is a block diagram of a DAB system that receives additional data, makes a database of the additional data, and allows interactive use of the database, according to an embodiment of the present invention;

FIG. 4A illustrates the syntax of additional data transmitted via a main service channel (MSC) according to an embodiment of the present invention;

FIG. 4B illustrates a format that corresponds to a field label and in which data is actually stored according to an embodiment of the present invention;

FIGS. 5A and 5B are examples of a database storing additional data shown in Table 1;

FIG. 6 illustrates data groups into which a database of additional data that will be transmitted to a receiver is divided according to an embodiment of the present invention; and

FIG. 7 is a flowchart of a method of interactively using additional data according to an embodiment of the present invention.

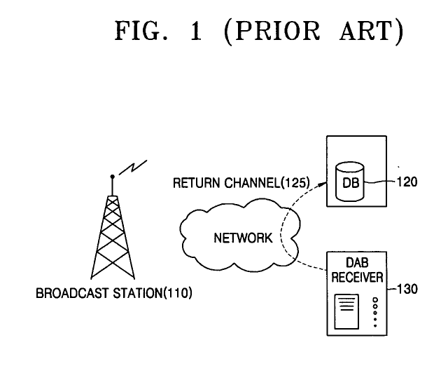

### DETAILED DESCRIPTION OF EMBODIMENT

Reference will now be made in detail to an embodiment of the present invention, examples of which are illustrated in the accompanying drawings, wherein like reference numerals refer to the like elements throughout. The embodiment is described below in order to explain the present invention by referring to the figures.

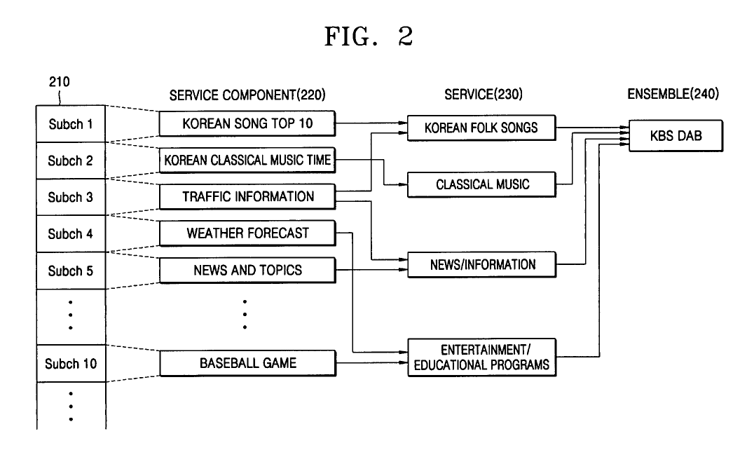

FIG. 2 is a diagram illustrating the relationship among services 230, service components 220, and sub channels 210 of digital audio broadcasting (DAB) according to an embodiment of the present invention. In the DAB, a plurality of the service components 220 constituting the services 230 are transmitted via a plurality of sub channels 210, respectively. In this embodiment, the plurality of services 230 form an ensemble 240. Here, the services 230 denote outputs such as program services or data services selected by a user, and the service components 220 denote elements of the services 230. The service components 220 are linked to one another according to multiplex configuration information (MCI). Also, each of the service components 220 is transmitted via a corresponding sub channel (SubCh) 210 or a fast information data channel (FIDC).

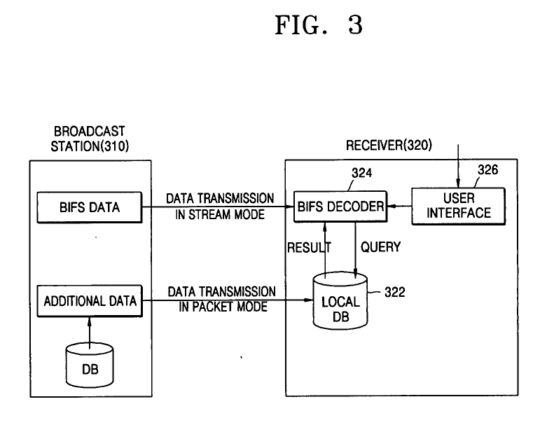

FIG. 3 is a block diagram of a DAB system that receives additional data, makes a database, and allows interactive use of the database according to an embodiment of the present invention.

DAB data is commonly transmitted in either a stream mode or a packet mode. In the steam mode, only data is transmitted at a fixed bit rate within a given sub channel without a header. In the packet mode, a packet is made by adding a header to data, so that various service components can be multiplexed and transmitted within a given sub channel.

Referring to FIG. 3, a DAB broadcast station 310 transmits additional data to a receiver 320 in the packet mode, and the receiver 320 receives the additional data and stores it in a local database (DB) 322. The additional data may be, by way of a non-limiting example, a detailed profile of a player transmitted together with a baseball game broadcast. In the stream mode, audio/video (AV) data and Binary Format for Scene (BIFS) data are transmitted. The BIFS data denotes a description regarding a screen composition. Also, the BIFS data is an extension of a virtual reality modeling language (VRML) that can realize virtual reality in an Internet virtual space. The BIFS data allows objects, which are encoded with natural or synthetic voice or images, to be arranged in a virtual time-space and a user to manipulate the objects. That is, the BIFS data allows interaction between the user and the DAB system. The description of the screen composition is converted into binary data so as to compress the description.

The BIFS data uses various types of nodes to compose a screen. The screen size or the positions of objects displayed on the screen can be changed according to a user input. Such interaction between the user and the DAB system can be performed through the BIFS data. In particular, a node in the BIFS data allows interaction between the user and the DAB system.

The received BIFS data is decoded by a BIFS decoder 324 to obtain a user interface, i.e., a BIFS node. When a user input is received via a user interface unit 326, a query regarding the user input is made using the BIFS node and transmitted to the local DB 322 so as to obtain desired information. The user interface is transmitted through a node of the BIFS data called ServerCommand. An example of the ServerCommand node is as follows:

ServerCommand {

| | | |
|---|---|---|
| eventIn | SFBool | trigger |

| | | |
|---|---|---|
| exposedField | SFBool | enable |
| exposedField | MFString | url |
| exposedField | SFString | command |
| }. | | |

In the ServiceCommand node, data in the “command” field becomes a query used for providing the user input to the local DB 322. The local DB 322 stores the additional data in a type of a relational database. The “url” field indicates the position of the local DB 322 of the receiver 320. The additional data stored in the local DB 322 is produced by the DAB broadcast station 310 and transmitted to the local DB 322 via a main service channel (MSC).

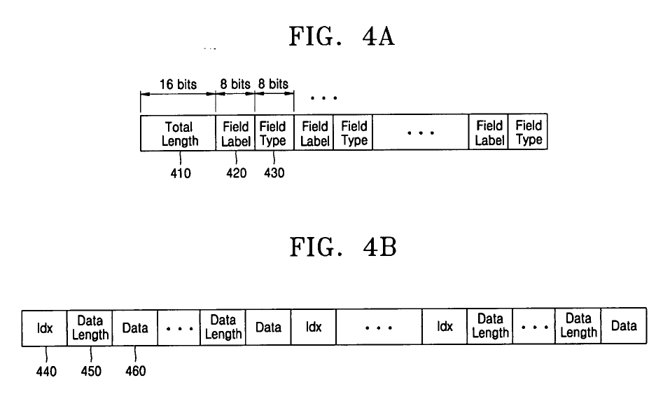

The construction of a database according to an embodiment of the present invention will now be described in greater detail. FIG. 4A illustrates the syntax of additional data transmitted via an MSC. Referring to FIG. 4A, a total length field 410 stores a total number of bits required to record all of the field data, which consists of field labels and field types. A field label 420 and a field type 430 are fields in which a field name, and the type of data stored in the field label 420 are recorded, respectively. For instance, the type of data such as an integer, a date, time, an image, or a currency that can be stored in the field label 420 may be recorded in the “field type” field 430. That is, the type of data recorded in the “field type” field 430 is not limited. As shown in FIG. 4A, the syntax of the additional data may include a plurality of field labels and a plurality of field types.

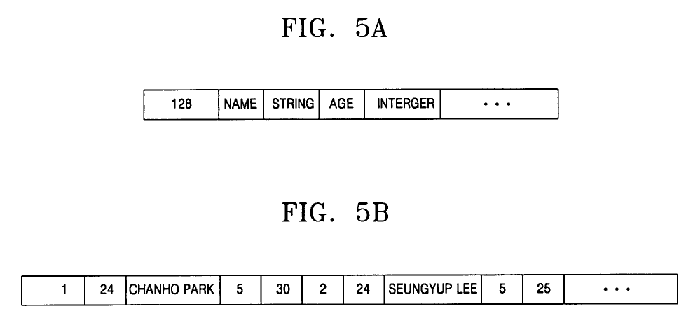

FIG. 4B illustrates a format that corresponds to a “field label” field and in which data is actually stored. Referring to FIG. 4B, Idx 440, data length 450, and data 460 denote an index of a field, the length of data 460, and data that is to be transmitted are recorded, respectively. Several pieces of data containing the data length 450 and the data 460 may belong to the “Idx” field 440. For instance, when transmitting additional data shown in Table 1, a database of the additional data can be made as shown in FIGS. 5A and 4B.

TABLE 1

| | Name | Age | . . . |
|---|---|---|---|
| 1 | Chanho Park | 30 | . . . |
| 2 | Seungyup Lee | 25 | . . . |
| . | . | . | . |
| . | . | . | . |
| . | . | . | . |

FIGS. 5A and 5B illustrate formats in which the additional data shown in Table 1 are stored as a database. Referring to FIG. 5A, the total number of bits of data, e.g., 128, required to record all the fields of data is stored in a “total length” field, “name” is stored in a first field label, and “string” is stored in a first “field type” field corresponding to the first field label. Also, “age” is stored in a next “field label” field and “integer” is stored in a next “field type” field corresponding to the next “field label” field.

FIG. 5B illustrates a format in which data is actually stored. Referring to FIG. 5B, “1” is stored in a first Idx field; a bit value of 24, which represents “Chanho Park”, is stored in a first data length field; and “Chanho Park” is stored in a first data field. A bit value of 5, which represents “30”, is stored in a second data length field, and “30” is stored in a second data field. Also, “2” is stored in a second Idx field, a bit value of 24, which represents “Seungyup Lee”, is stored in a third data length field, and “Seungyup Lee” is stored in a third data field. Also, a bit value of 5, which represents “25”, is stored in a fourth data length field, and “25” is stored in a third data field.

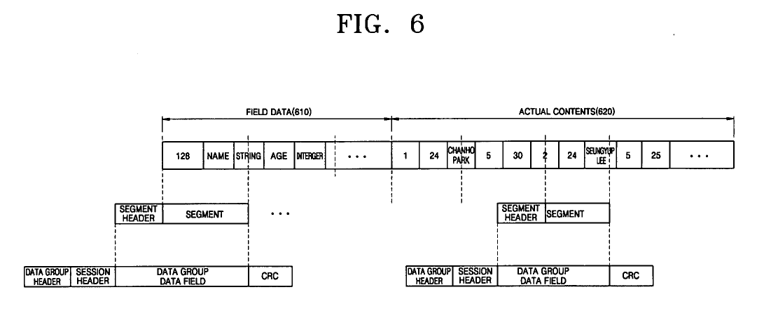

FIG. 6 illustrates data groups into which a database of additional data that will be transmitted to a receiver is divided according to an embodiment of the present invention. Referring to FIG. 6, the additional data made in formats of FIGS. 5A and 5B is divided into segments, and the segments are divided into data groups and transmitted to the receiver. Referring to FIG. 6, field data 610 and actual contents 620 are divided into segments of different sizes, divided into groups, and transmitted to the receiver, respectively.

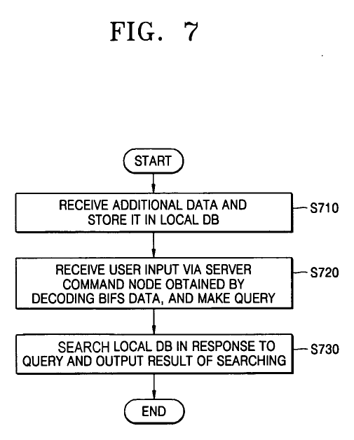

FIG. 7 is a flowchart of a method of interactively using additional data according to an embodiment of the present invention. Referring to FIG. 7, a database of additional data is received and stored in a local DB (S710). The type of database may be those illustrated by FIGS. 4A and 4B. Next, information, e.g., BIFS data, regarding a screen composition, which is contained in service data, is decoded to make a node using the node, a user input is received, and the user input is transformed into a query that requests a search for the database, and the query is output (S720). Next, the local DB is searched for in response to the query and the result of searching is output (S730).

A method of interactively using additional data according to the present embodiment can be embodied as a computer program. Also, the program may be stored in a computer readable medium that is read and executed by a computer to realize the method. The computer readable medium may be any medium, such as a magnetic recording medium, an optical recording medium, and a carrier wave.

According to the above-described embodiment of the present invention, a DAB receiver includes a simpler, small-sized database that allows a dynamic service to be provided to a user without accessing a database installed in a remote place.

Although a embodiment of the present invention have been shown and described, the present invention is not limited to the described embodiment. Instead, it would be appreciated by those skilled in the art that changes may be made to the embodiment without departing from the principles and spirit of the invention, the scope of which is defined by the claims and their equivalents.

What is claimed is:

1. A method of interactively using additional data, comprising:
receiving the additional data and storing the received additional data in a specified database;
receiving a user input via a user input interface obtained by decoding information regarding a screen composition contained in service data, transforming the user input into a query that requests a search of the database, and outputting the query; and
searching the database in response to the query and outputting a result of the searching.

2. The method of claim 1, wherein the database is a relational database.

3. The method of claim 2, wherein the relational database includes:
a field including at least one pair of a field label that categorizes stored data and a field type that represents a format in which the field label is stored; and
field data including at least one pair of an index, and at least one piece of data corresponding to the index and a length of the data.

4. The method of claim 1, wherein the additional data is received in a packet mode in digital audio broadcasting.

5. The method of claim 1, wherein the information regarding the screen composition is received in a stream mode in digital audio broadcasting, and binary format for scene (BIFS) data.

6. The method of claim 1, wherein the user input interface is a BIFS node.

7. The method of claim 1, wherein the receiving a user input includes:
decoding the information regarding the screen composition contained in the service data, to make the user input interface; and
receiving a user input via the user input interface, transforming the user input into the query using a BIFS server command constituting the information regarding the screen composition, and outputting the query.

8. The method of claim 7, wherein the BIFS server command includes:
a uniform resource locator (URL) indicating a position of the database that is to be searched in response to the query; and
a command received via the user input interface.

9. An apparatus for processing additional data, comprising:
a local database receiving the additional data and storing the received additional data; and
a decoder decoding information regarding a screen composition to make a user input interface, receiving a user input via the user input interface, transforming the user input into a query that requests a search of the local database, and outputting the query.

10. The apparatus of claim 9, wherein the local database receives the query, searches data in the local database, and outputs a result of the searching.

11. The apparatus of claim 9, wherein the database is a relational database.

12. The apparatus of claim 11, wherein the relational database includes:
a field including at least one pair of a field label that categorizes stored data and a field type that represents a format in which the field label is stored; and
field data including at least one pair of an index and at least one piece of data corresponding to the index and a length of the data.

13. The apparatus of claim 9, wherein the information regarding the screen composition is received in a stream mode in digital audio broadcasting, and binary format for scene (BIFS) data.

14. The apparatus of claim 9, wherein the user input interface is a BIFS node.

15. A computer-readable storage medium encoded with processing instructions for causing a processor to perform a method of interactively using additional data, the method comprising:
receiving additional data and storing the received additional data in a specified database;
receiving a user input via a user input interface obtained by decoding information regarding a screen composition contained in service data, transforming the user input into a query that requests a search of the database, and outputting the query; and
searching the database in response to the query and outputting a result of the searching.

16. A digital audio broadcast (DAB) system, comprising:
a broadcast station transmitting binary format for scene (BIFS) data in a stream mode and additional data in a packet mode;
a receiver having a BIFS decoder and a database, the receiver receiving the transmitted BIFS data and the transmitted additional data, storing the received additional data in the DB, the BIFS decoder decoding the received BIFS data to obtain a BIFS node receiving user input; and
a user interface,
wherein, when a user input is received by the user interface, a query regarding the user input is made using the BIFS node and the database is searched to satisfy the query.

17. The system of claim 16, wherein the BIFS data is an extension of a virtual reality modeling language (VRML) that realizes virtual reality in an Internet virtual space.

18. The system of claim 17, wherein the BIFS data allows objects encoded with natural or synthetic voice or images, to be arranged in a virtual time-space and allows a user to manipulate the objects.
